(19) United States
(12) Patent Application Publication
(10) Pub. No.: US 2012/0106541 A1
(43) Pub. Date: May 3, 2012

(54) IP PHONE AND DESKTOP SHARING METHOD

(75) Inventor: CHI-CHUNG SU, Tu-Cheng (TW)

(73) Assignee: HON HAI PRECISION INDUSTRY CO., LTD., Tu-Cheng (TW)

(21) Appl. No.: 13/083,603

(22) Filed: Apr. 11, 2011

(30) Foreign Application Priority Data
Oct. 29, 2010 (CN) 201010524858.X

(51) Int. Cl. H04L 12/66

(52) U.S. Cl. 370/352

(57) ABSTRACT

An Internet protocol (IP) phone establishes a voice communication with a remote IP phone, and establishes a desktop sharing connection with the remote IP phone upon a sharing key being pressed. The IP phone captures local desktop display data of a local computer, and transmits the local desktop display data to the remote IP phone over the Internet. The IP phone receives remote desktop display data of a remote computer from the remote IP phone over the Internet, and outputs the remote desktop display data to the local computer to display the remote desktop display data on the local computer.

### BACKGROUND

1. Technical Field

The present disclosure relates to network communications, and more particularly to an Internet protocol (IP) phone and a desktop sharing method.

2. Description of Related Art

When people are on a call, one calling party can share his/her desktop of his/her computer to the other calling party. Some configuration and setup software are commonly used to share the desktop, such as using CISCO WebEx or MICROSOFT Netmeeting.

However, the above-mentioned products require additional installing cost and needs to pre-setup a meeting before a conference starts, which has a high cost and is not convenient.

### BRIEF DESCRIPTION OF THE DRAWINGS

The details of the disclosure, both as to its structure and operation, can be best understood by referring to the accompanying drawings, in which like reference numbers and designations refer to like elements.

FIG. 1 is schematic diagram of an application environment of one embodiment of a local Internet protocol (IP) phone in accordance with the present disclosure;

FIG. 2 is a schematic diagram of functional modules of a local IP phone in accordance with the present disclosure;

FIG. 3 is a flowchart of one embodiment of a desktop sharing method in accordance with the present disclosure; and

FIG. 4 is a flowchart of another embodiment of a desktop sharing method in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

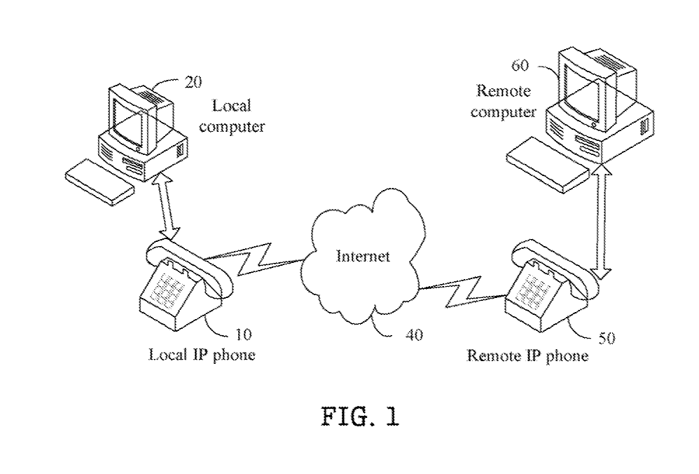

FIG. 1 is schematic diagram of an application environment of one embodiment of a local Internet protocol (IP) phone 10 in accordance with the present disclosure. In one embodiment, the local IP phone 10 is in electronic communication with a local computer 20, and also in electronic communication with a remote IP phone 50 over the Internet 40. The remote IP phone 50 is also in electronic communication with a remote computer 60.

In one embodiment, the local IP phone 10 may be connected to the local computer 20 via a video graphic array (VGA) interface or a local area network (LAN) interface. The LAN interface may be a RJ-45 port, for example. The remote IP phone 50 may be connected to the remote computer 60 via another VGA interface or another LAN interface.

In one embodiment, the local IP phone 10 establishes a voice communication with the remote IP phone 50 over the Internet 40. In one example, the local IP phone 10 establishes a voice over Internet protocol (VoIP) communication with the remote IP phone 50. Subsequently, the local IP phone 10 establishes a desktop sharing connection with the remote IP phone 50.

In one embodiment, if a user of the local IP phone 10 wants to share local desktop display data of the local computer 20 with a user of the remote IP phone 50, the user of the local IP phone 10 can press a sharing key of the local IP phone 10. Accordingly the local IP phone 10 transmits a desktop sharing request to the remote IP phone 50 over the Internet 40 in response to the sharing key being pressed. Thus, the remote IP phone 50 consequently transmits a desktop sharing response to the local IP phone 50 to confirm the desktop sharing request and start desktop sharing.

The local IP phone 10 captures local desktop display data of the local computer 20, and transmits the local desktop display data of the local computer 20 to the remote IP phone 50 over the Internet 40. When receiving the local desktop display data over the Internet 40, the remote IP phone 50 outputs the local desktop display data to the remote computer 60 and the remote computer 60 display the local desktop display data. In this way, the user of the local IP phone 10 successfully shares the local desktop display data of the local computer 20 with the user of the remote IP phone 50.

In another embodiment, if the user of the remote IP phone 50 wants to share remote desktop display data of the remote computer 60 with the user of the local IP phone 10, the user of the remote IP phone 50 presses the sharing key of the remote IP phone 50. Accordingly, the remote IP phone 50 transmits a desktop sharing request to the local IP phone 10 over the Internet 40 in response to the sharing key being pressed. If accepting the desktop sharing request, the user of the local IP phone 10 presses the sharing key of the local IP phone 10, and the local IP phone 10 consequently transmits a desktop sharing response to the remote IP phone 50 to confirm the desktop sharing request and start desktop sharing.

Subsequently, the remote IP phone 50 captures remote desktop display data of the remote computer 60, and transmits the remote desktop display data of the remote computer 60 to the local IP phone 10 over the Internet 40. When receiving the remote desktop display data over the Internet 40, the local IP phone 10 outputs the remote desktop display data to the local computer 20 and the local computer 20 displays the remote desktop display data. In this way, the user of remote IP phone 50 successfully shares the remote desktop display data of the remote computer 60 with the user of the local IP phone 10.

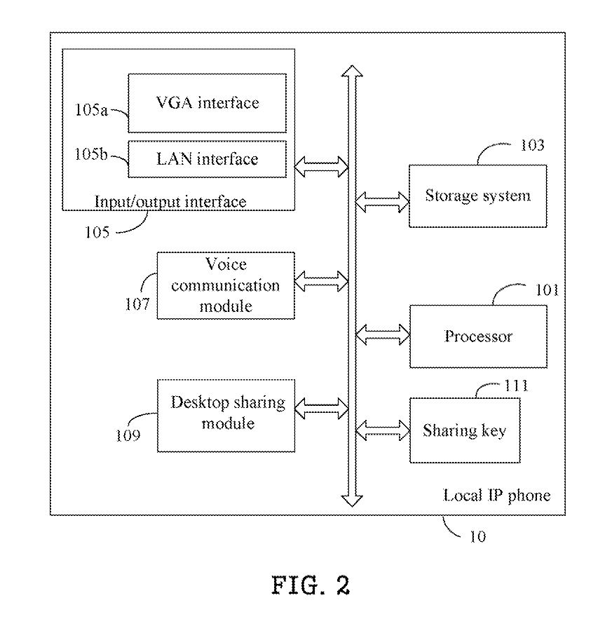

FIG. 2 is a schematic diagram of functional modules of the local IP phone 10 in accordance with the present disclosure. In one embodiment, functional modules of the local IP phone 10 are the same as those of the remote IP phone 50 shown in FIG. 1. In order to describe briefly, only functional modules of the local IP phone 10 are introduced.

In one embodiment, the local IP phone 10 includes at least one processor 101, a storage system 103, an input/output interface 105, a voice communication module 107, a desktop sharing module 109, and a sharing key 111. The modules 107 and 109 may comprise computerized code in the form of one or more programs that are stored in the storage system 103. The computerized code includes instructions that are executed by the at least one processor 101 to provide functions for the modules 107 and 109. In one example, the storage system 103 may be a hard disk drive, flash memory, or other computerized memory device.

The voice communication module 107 is operable to establish a voice communication with the remote IP phone 50. In one embodiment, the voice communication module 107 establishes a VoIP communication with the remote IP phone 50.

The desktop sharing module 109 is operable to establish a desktop sharing connection with the remote IP phone 50 upon the sharing key 111 being pressed.

In one example, if the user of the local IP phone 10 wants to share local desktop display data of the local computer 20 with the user of the remote IP phone 50, the user of the local IP phone 10 presses the sharing key 111. The desktop sharing module 109 transmits a desktop sharing request to the remote IP phone 50 over the Internet 40 in response to the sharing key 111 being pressed, and receives a desktop sharing response from the remote IP phone 50 over the Internet 40.

In another example, if the user of the remote IP phone 50 wants to share remote desktop display data of the remote computer 60 with the user of the local IP phone 10, the user of the remote IP phone 50 presses a sharing key of the remote IP phone 50. Accordingly, the remote IP phone 50 transmits a desktop sharing request to the local IP phone 10 over the Internet 40, and the desktop sharing module 109 receives the desktop sharing request from the remote IP phone 50 over the Internet 40. If accepting the desktop sharing request, the user of the local IP phone 10 will press the sharing key 111. Accordingly, the local IP phone 10 transmits a desktop sharing response to the remote IP phone 50 in response to the sharing key 111 being pressed.

The desktop sharing module 109 is further operable to capture local desktop display data of the local computer 20 from the local computer 20 via the input/output interface 105, and transmit the local desktop display data to the remote IP phone 50 over the Internet 40, so that the local desktop display data is outputted from the remote IP phone 50 to the remote computer 60 and displayed on the remote computer 60. In this way, the user of the local IP phone 10 shares the local desktop display data of the local computer 20 with the user of the remote IP phone 50.

In one embodiment, the input/output interface 105 may include a VGA interface 105a, and the local desktop display data may include analog data. In such a case, the desktop sharing module 109 captures the analog data of the local desktop display data from the local computer 20 via the VGA interface 105a, and transforms the analog data of the local desktop display data to digital data of the local desktop display data. Then, the desktop sharing module 109 transmits the digital data of the local desktop display data to the remote IP phone 50 over the Internet 40.

In another embodiment, the input/output interface 105 may include a LAN interface 105b such as a RJ45 port, and the local desktop display data may include digital data. In such a case, the desktop sharing module 109 captures the digital data of the local desktop display data from the local computer 20 via the LAN interface 105b, and transmits the digital data of the local desktop display data to the remote IP phone 50 over the Internet 40.

The desktop sharing module 109 is further operable to receive remote desktop display data of the remote computer 60 from the remote IP phone 50 over the Internet 40, and outputs the remote desktop display data to the local computer 20 via the input/output interface 105 to display the remote desktop display data on the local computer 20. In this way, the user of the remote IP phone 50 shares the remote desktop display data of the remote computer 60 with the user of the local IP phone 10.

In one embodiment, the input/output interface 105 may include the VGA interface 105a, and the remote desktop display data may include digital data. In such a case, the desktop sharing module 109 receives the digital data of the remote desktop display data from the remote IP phone 50 over the Internet 40, and transforms the digital data of the remote desktop display data to analog data of the remote desktop display data. Then, the desktop sharing module 109 outputs the analog data of the remote desktop display data to the local computer 20 to display the remote desktop display data on the local computer 20.

In another embodiment, the input/output interface 105 may include the LAN interface 105b such as a RJ45 port, and the remote desktop display data may include digital data. In such a case, the desktop sharing module 109 receives the digital data of the remote desktop display data from the remote IP phone 50 over the Internet 40, and outputs the digital data of the remote desktop display data to the local computer 20 via the LAN interface 105b to display the remote desktop display data on the local computer 20.

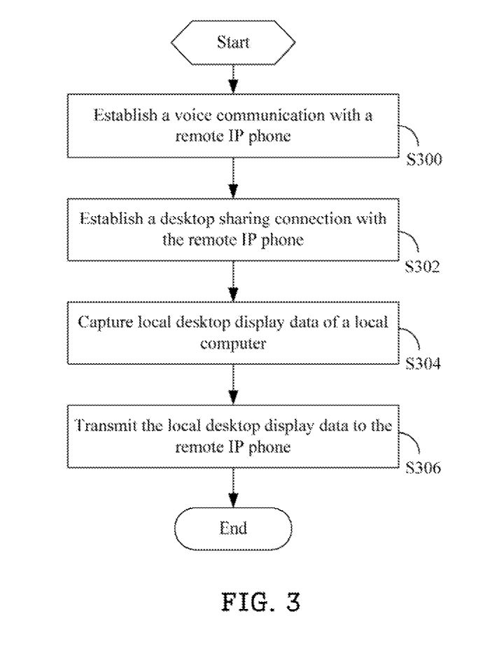

FIG. 3 is a flowchart of one embodiment of a desktop sharing method in accordance with the present disclosure. In one embodiment, the desktop sharing method may be embodied in the local IP phone 10, and is executed by the functional modules such as those of FIG. 2. Depending on the embodiment, additional blocks may be added, others deleted, and the ordering of the blocks may be changed while remaining well within the scope of the disclosure.

In block S300, the voice communication module 107 establishes a voice communication with the remote IP phone 50. In one embodiment, the voice communication module 107 establishes a VoIP communication with the remote IP phone 50.

In block S302, the desktop sharing module 109 establishes a desktop sharing connection with the remote IP phone 50 upon the sharing key 111 being pressed. In one embodiment, the desktop sharing module 109 transmits a desktop sharing request to the remote IP phone 50 in response to the sharing key 111 being pressed, and receives a desktop sharing response from the remote IP phone 50.

In block S304, the desktop sharing module 109 captures local desktop display data of the local computer 20 from the local computer 20 via the input/output interface 105.

In block S306, the desktop sharing module 109 transmits the local desktop display data to the remote IP phone 50 over the Internet 40, so that the local desktop display data is outputted from the remote IP phone 50 to the remote computer 60 and displayed on the remote computer 60. In one embodiment, the local desktop display data may include analog or digital data.

In one example, the desktop sharing module 109 may capture the analog data of the local desktop display data from the local computer 20 via the VGA interface 105a, transform the analog data of the local desktop display data to digital data of the local desktop display data, and transmit the digital data of the local desktop display data to the remote IP phone 50 over the Internet 40.

In another example, the desktop sharing module 109 may capture the digital data of the local desktop display data from the local computer 20 via the LAN interface 105b, and transmit the digital data of the local desktop display data to the remote IP phone 50 over the Internet 40.

Thus, the user of the local IP phone 10 shares the local desktop display data of the local computer 20 with the user of the remote IP phone 50.

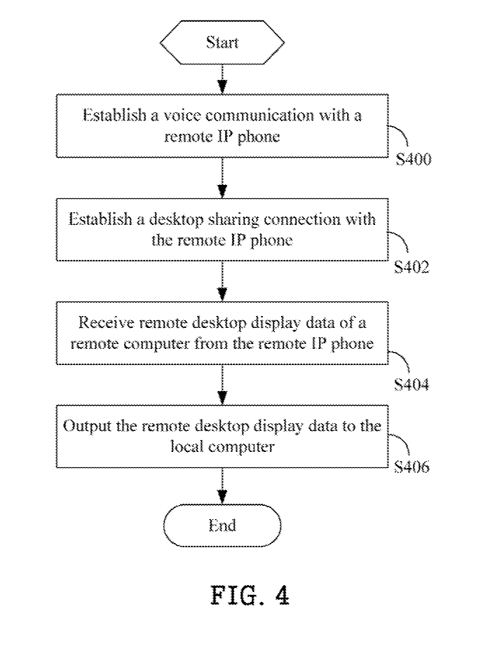

FIG. 4 is a flowchart of another embodiment of a desktop sharing method in accordance with the present disclosure. In one embodiment, the desktop sharing method may be embodied in the local IP phone 10, and is executed by the functional modules such as those of FIG. 2. Depending on the embodiment, additional blocks may be added, others deleted, and the ordering of the blocks may be changed while remaining well within the scope of the disclosure.

In block S400, the voice communication module 107 establishes a voice communication with the remote IP phone 50.

In block S402, the desktop sharing module 109 establishes a desktop sharing connection with the remote IP phone 50 upon the sharing key 111 being pressed. In one embodiment, the desktop sharing module 109 receives a desktop sharing request from the remote IP phone 50 over the Internet 40, and transmits a desktop sharing response to the remote IP phone 50 over the Internet 40 in response to the sharing key 111 being pressed.

In block S404, the desktop sharing module 109 receives remote desktop display data of the remote computer 60 from the remote IP phone 50 over the Internet 40.

In block S406, the desktop sharing module 109 outputs the remote desktop display data to the local computer 20 via the input/output interface 105 to display the remote desktop display data on the local computer 20. In one embodiment, the remote desktop display data may include digital data.

In one example, the desktop sharing module 109 may receive the digital data of the remote desktop display data from the remote IP phone 50 over the Internet 40, and transform the digital data of the remote desktop display data to analog data of the remote desktop display data. Then, the desktop sharing module 109 may output the analog data of the remote desktop display data to the local computer 20 via the VGA interface 105a to display the remote desktop display data on the local computer 20.

In another example, the desktop sharing module 109 may receive the digital data of the remote display data from the remote IP phone 50 over the Internet 40, and then output the digital data of the remote display data to the local computer 20 via the LAN interface 105b to display the remote desktop display data on the local computer 20.

Thus, the user of the remote IP phone 50 shares the remote desktop display data of the remote computer 60 with the user of the local IP phone 10.

In conclusion, the users of the local IP phone 10 and the remote IP phone 50 share the local desktop display data and the remote desktop display data with each other, which has a low cost and is very convenient.

While various embodiments of the present disclosure have been described above, it should be understood that they have been presented using example and not using limitation. Thus the breadth and scope of the present disclosure should not be limited by the above-described embodiments, but should be defined in accordance with the following claims and their equivalents.

What is claimed is:

1. An Internet protocol (IP) phone in electronic communication with a local computer as well as in electronic communication over the Internet with a remote IP phone electronically connected to a remote computer, the IP phone comprising:
an input/output interface connected to the local computer;
a sharing key;
a storage system;
at least one processor;
one or more programs that are stored in the storage system and are executed by the at least one processor, the one or more programs comprising:
a voice communication module operable to establish a voice communication with the remote IP phone; and
a desktop sharing module operable to establish a desktop sharing connection with the remote IP phone upon the sharing key being pressed, capture local desktop display data of the local computer from the local computer via the input/output interface, and transmit the local desktop display data to the remote IP phone over the Internet, so that the local desktop display data is outputted from the remote IP phone to the remote computer and displayed on the remote computer.

2. The IP phone of claim 1, wherein the desktop sharing module is further operable to receive remote desktop display data of the remote computer from the remote IP phone over the Internet, and output the remote desktop display data to the local computer via the input/output interface to display the remote desktop display data on the local computer.

3. The IP phone of claim 2, wherein the input/output interface comprises a video graphic array (VGA) interface, the local desktop display data comprises analog data, and the remote desktop display data comprises digital data.

4. The IP phone of claim 3, wherein the desktop sharing module captures the analog data of the local desktop display data from the local computer via the VGA interface, transforms the analog data of the local desktop display data to digital data of the local desktop display data, and transmits the digital data of the local desktop display data to the remote IP phone over the Internet.

5. The IP phone of claim 4, wherein the desktop sharing module receives the digital data of the remote desktop display data from the remote IP phone over the Internet, transforms the digital data of the remote desktop display data to analog data of the remote desktop display data, and outputs the analog data of the remote desktop display data to the local computer via the VGA interface to display the remote desktop display data on the local computer.

6. The IP phone of claim 2, wherein the input/output interface comprises a local area network (LAN) interface, the local desktop display data and the remote desktop display data comprise digital data.

7. The IP phone of claim 6, wherein the desktop sharing module captures the digital data of the local desktop display data via the LAN interface, and transmits the digital data of the local desktop display data to the remote IP phone over the Internet.

8. The IP phone of claim 7, wherein the desktop sharing module receives the digital data of the remote desktop display data from the remote IP phone over the Internet, and outputs the digital data of the remote desktop display data to the local computer via the LAN interface to display the remote desktop display data on the local computer.

9. The IP phone of claim 1, wherein the desktop sharing module transmits a desktop sharing request to the remote IP phone over the Internet in response to the sharing key being pressed, and receives a desktop sharing response from the remote IP phone over the Internet.

10. The IP phone of claim 9, wherein the desktop sharing module further receives another desktop sharing request from the remote IP phone over the Internet, and transmits another desktop sharing response to the remote IP phone over the Internet in response to the sharing key being pressed.

11. A desktop sharing method of a local Internet protocol (IP) phone in electronic communication with a local computer as well as in electronic communication over the Internet with a remote IP phone electronically connected to a remote computer, the desktop sharing method comprising:
providing a sharing key for the local IP phone;
establishing a voice communication between the local IP phone and the remote IP phone;
establish a desktop sharing connection between the local IP phone and the remote IP phone upon the sharing key being pressed;
capturing local desktop display data of the local computer from the local computer via an input/output interface; and
transmitting the local desktop display data to the remote IP phone over the Internet so that the local desktop display data is outputted from the remote IP phone to the remote computer and displayed on the remote computer.

12. The desktop sharing method of claim 11, further comprising:
receiving remote desktop display data of the remote computer from the remote IP phone over the Internet; and
outputting the remote desktop display data to the local computer via the input/output interface to display the remote desktop display data on the local computer.

13. The desktop sharing method of claim 12, wherein the input/output interface comprises a video graphic array (VGA) interface, the local desktop display data comprises analog data, and the remote desktop display data comprises digital data.

14. The desktop sharing method of claim 13, wherein the capturing and transmitting steps comprise:
capturing the analog data of the local desktop display data from the local computer via the VGA interface;
transforming the analog data of the local desktop display data to digital data of the local desktop display data; and
transmitting the digital data of the local desktop display data to the remote IP phone over the Internet.

15. The desktop sharing method of claim 13, wherein the receiving and outputting steps comprise:
receiving the digital data of the remote desktop display data from the remote IP phone over the Internet;
transforming the digital data of the remote desktop display data to analog data of the remote display data; and
outputting the analog data of the remote desktop display data to the local computer via the VGA interface to display the remote desktop display data on the local computer.

16. The desktop sharing method of claim 12, wherein the input/output interface comprises a local area network (LAN) interface, and the local desktop display data and the remote desktop display data comprise digital data.

17. The desktop sharing method of claim 16, wherein the capturing and transmitting steps comprise:
capturing the digital data of the local desktop display data from the local computer via the LAN interface; and
transmitting the digital data of the local desktop display data to the remote IP phone over the Internet.

18. The desktop sharing method of claim 16, wherein the receiving and outputting steps comprise:
receiving the digital data of the remote desktop display data from the remote IP phone over the Internet; and
outputting the digital data of the remote desktop display data to the local computer via the LAN interface to display the remote desktop display data on the local computer.

19. The desktop sharing method of claim 11, wherein the step of establishing a desktop sharing connection between the local IP phone and the remote IP phone comprises:
transmitting a desktop sharing request to the remote IP phone in response to the sharing key being pressed; and
receiving a desktop sharing response from the remote IP phone.

20. The desktop sharing method of claim 11, wherein the step of establishing a desktop sharing connection between the local IP phone and the remote IP phone comprises:
receiving a desktop sharing request from the remote IP phone over the Internet; and
transmitting a desktop sharing response to the remote IP phone over the Internet in response to the sharing key being pressed.
